(19) United States
(12) Patent Application Publication
(10) Pub. No.: US 2010/0033509 A1
(43) Pub. Date: Feb. 11, 2010

(54) IMAGE DISPLAY DEVICE

(75) Inventor: Kazuki Sawa, Osaka (JP)

Correspondence Address: RATNERPRESTIA, P.O. BOX 980, VALLEY FORGE, PA, 19482, US

(73) Assignee: Panasonic Corporation, Osaka (JP)

(21) Appl. No.: 12/446,626

(22) PCT Filed: Feb. 29, 2008
(86) PCT No.: PCT/JP2008/000393

§ 371 Date: Apr. 22, 2009

(30) Foreign Application Priority Data
Mar. 1, 2007 (JP) 2007-050995

(51) Int. Cl. G09G 5/10; G09G 3/28

(52) U.S. Cl. 345/690; 345/60

(57) ABSTRACT

An image display device includes an error diffusion circuit for limiting the gradation level of an image signal to that displayable on the image display device, and diffusing error data produced by the limitation to neighboring pixels. The error diffusion circuit includes an error replacement unit for replacing the error data with fixed-value data in a predetermined period of the image signal.

### TECHNICAL FIELD

The present invention relates to image display devices equipped with an error diffusion circuit.

### BACKGROUND ART

Plasma display devices, which are a type of image display device, can display images at high speed, have a wide viewing angle, and can easily be made in large screen sizes. Their light-emitting feature also achieves a high display quality. These characteristics have resulted in plasma display devices being commonly adopted as display devices in places where many people gather or for watching images on a large screen at home.

The number of bits of image data displayable on a display device, such as a plasma display device, is limited. Therefore, if image data with the number of bits greater than the number of bits of displayable image data is input, an error occurs in the gradation of images displayed, resulting in poor gradation reproduction. A method is therefore employed, called error diffusion, to display images by expressing a pseudo level of gradation close to the accuracy of bits of the input image data using the number of bits smaller than the number of bits of input image data.

However, since error diffusion is a system of expressing an image in pseudo-gradations by accumulating error components, uneven brightness occurs on the left or top part of the screen where error components are not sufficiently accumulated, or the display starting position of the image appears to have moved.

FIGS. 12A and 12B illustrate these disadvantages of a conventional error diffusion circuit. FIG. 12A is an example of an image displayed after applying error diffusion to an input image data whose gradation in area 900, the entire area of display area 91, is “1.” In this case, a rectangular image corresponding to the input image data is not accurately displayed, and area 902, which consists of the top, left and upper left parts of rectangular area 900, is missing in the image displayed. If the gradation of input image data is small, like this example, error data to be diffused to neighboring pixels is also small, and the value of the error data diffused from the neighboring pixels is also small. Therefore, several pixels on the left or a few upper lines, such as area 902, require a preparation period for error data to accumulate and reach “1.” In addition, even if the gradation of the input image data is sufficiently large, a difference in brightness between area 901 and area 902 in FIG. 12A becomes obvious if a gradation level of lower bits in input image data, which becomes error data, is small, causing uneven brightness.

FIG. 12B is an example of an image displayed after applying error diffusion to the input image data whose gradation in small area 910 inside display area 91 is “1,” and gradation in a remaining area is “0.” Also in this case, uneven brightness or missing image occurs in area 912, which consists of the top, left, and upper left parts of area 910.

To solve these disadvantages of the error diffusion circuit, one prior art proposes reducing deviation at the display starting position by applying an additional signal to the display starting area of the image so as to faster accumulate error data for error diffusion. This prior art is disclosed in Patent Document 1. Another prior art proposes adding error data of pixels in the last display line to the error data of pixels in the first display line of the next frame so as to eliminate uneven brightness by compensating for insufficient error data of pixels at the upper left part of the display screen. This prior art is disclosed in Patent Document 2.

The prior art in Patent Document 1 improves deviation in the display starting position. However, the difference in brightness between an area where additional signal is applied and an area without additional signal is too obvious. This results in loss of picture quality. In addition, if the effect on the display image is considered, a large additional signal cannot be applied. This results in insufficient prevention of deviation at the display starting position.

The prior art in Patent Document 2 cannot suppress uneven brightness or deviation in display position if an image is displayed in a small area, as shown in FIG. 12B.

Patent Document 1: Japanese Patent Unexamined Publication No. 2003-46776

Patent Document 2: Japanese Patent Unexamined Publication No. H9-244576

### SUMMARY OF THE INVENTION

In an image display device, one field is configured with multiple subfields. Images are displayed in multi-gradations by controlling on and off of light emission from each pixel of the display device in each sub-field. The display device includes an error diffusion circuit that limits an image signal to a grayscale level displayable on the display device, and diffuses error data produced by the limitation to neighboring pixels. The error diffusion circuit includes an error replacement unit for replacing error data with predetermined fixed-value data in a predetermined period before an image signal to be displayed on a display screen is input to the error diffusion circuit in one vertical scan period and a predetermined period before the image signal to be displayed on the display screen is input to the error diffusion circuit in one horizontal scan period.

### BRIEF DESCRIPTION OF DRAWINGS

FIG. 1 is an exploded perspective view illustrating a key part of a plasma display panel in an exemplary embodiment of the present invention.

FIG. 2 illustrates an electrode alignment of the plasma display panel.

FIG. 3 illustrates a drive voltage waveform applied to each electrode of the plasma display panel.

FIG. 4 is a circuit block diagram of the plasma display panel.

FIG. 5 is a circuit block diagram of an error diffusion circuit in the plasma display panel.

FIG. 6 illustrates an error replacement period in accordance with the exemplary embodiment of the present invention.

FIG. 7 is a detailed block diagram of a key part of the error diffusion circuit in accordance with the exemplary embodiment of the present invention.

FIG. 8A illustrates how error data is diffused in accordance with the exemplary embodiment of the present invention.

FIG. 8B illustrates how error data is diffused in accordance with the exemplary embodiment of the present invention.

FIG. 9 is a block diagram illustrating a detailed structure of a key part of another error diffusion circuit in accordance with the exemplary embodiment of the present invention.

FIG. 10 is a block diagram illustrating a detailed structure of a key part of still another error diffusion circuit in accordance with the exemplary embodiment of the present invention.

FIG. 11 is a block diagram illustrating a detailed structure of a key part of further another error diffusion circuit in accordance with the exemplary embodiment of the present invention.

FIG. 12A illustrates a disadvantage of a conventional error diffusion circuit.

FIG. 12B illustrates a disadvantage of the conventional error diffusion circuit.

### REFERENCE MARKS IN THE DRAWINGS

10 Panel
12 Image signal processing circuit
13 Data electrode drive circuit
14 Scan electrode drive circuit
15 Sustain electrode drive circuit
16 Timing generating circuit
21 Front substrate
22 Scan electrode
23 Sustain electrode
24 Display electrode pair
25 Dielectric layer
26 Protection layer
31 Rear substrate
32 Data electrode
33 Dielectric layer
34 Rib
35 Phosphor layer
40, 40A, 40B, 40C Error addition unit
41, 42 Adder
50, 50A, 50B, 50C Delay unit
51, 52, 53, 54, 59 Delay device
60, 60A, 60B, 60C, 60D Error replacement unit
61, 62, 63, 64, 69 Multiplier
65, 66, 67, 68 Selector
70 Timing generator
71 Counter
72 Replacement signal generator
80 Error replacement area
81 Display area
91 Display area
120 Error diffusion circuit
121 Subfield processing circuit

### DETAILED DESCRIPTION OF PREFERRED EMBODIMENTS

An image display device of the present invention solves the aforementioned disadvantages. The image display device includes an error diffusion circuit that can suppress the generation of uneven brightness and positional deviation of an image, regardless of image display position or the size of the input signal, without damaging the picture quality of the image displayed.

An exemplary embodiment of the present invention is described below with reference to drawings.

### Exemplary Embodiment

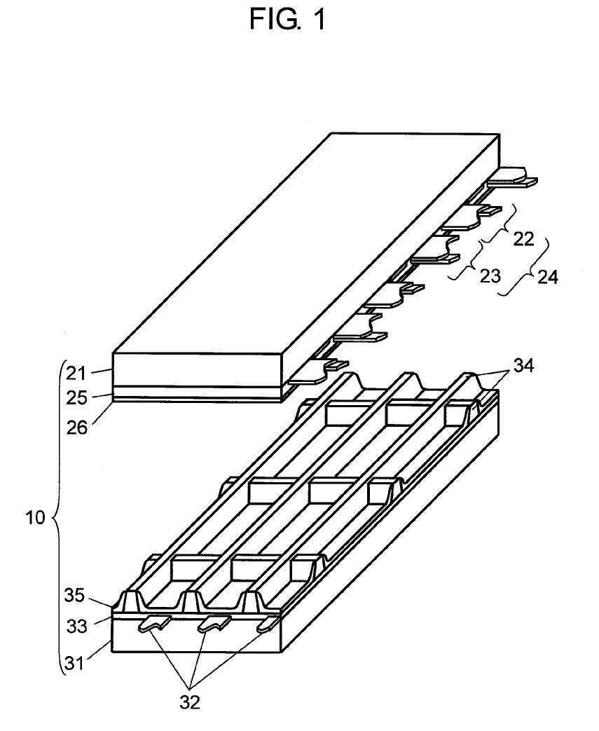

FIG. 1 is an exploded perspective view of a key part of a plasma display panel in the exemplary embodiment of the present invention. Panel 10 is configured to form a discharge space between glass front substrate 21 and rear substrate 31 facing each other. Multiple pairs of scan electrode 22 and sustain electrode 23 are aligned in parallel on front substrate 21. These configure display electrode pairs 24. Dielectric layer 25 covers scan electrodes 22 and sustain electrodes 23, and protective layer 26 is formed over dielectric layer 25. Multiple data electrodes 32 are formed on rear substrate 31, and dielectric layer 33 is formed covering these data electrodes 32. Grid-like ribs 34 are provided on dielectric layer 33. Phosphor layer 35 is also provided on the surface of dielectric layer 33 and the side face of ribs 34. Front substrate 21 and rear substrate 31 are disposed facing each other such that scan electrodes 22 and sustain electrodes 23 cross with data electrodes 32. A discharge space formed between these substrates is filled with discharge gas such as mixed gas of neon and xenon. However, the structure of panel 10 is not limited to the above structure. For example, striped ribs may be provided.

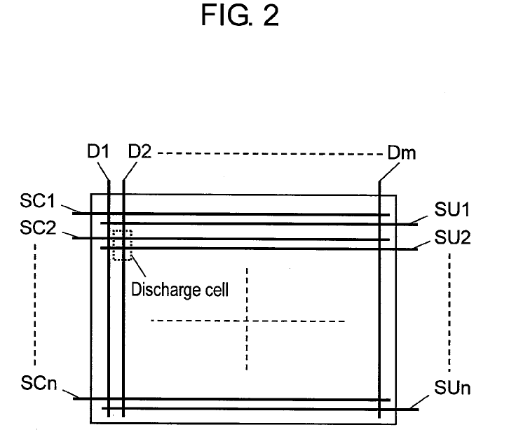

FIG. 2 is an electrode layout of panel 10 of the plasma display device in the exemplary embodiment of the present invention. The n lines of scan electrodes SC1 to SCn (Scan electrode 22 in FIG. 1) and the n lines of sustain electrodes SU1 to SUn (sustain electrode 23 in FIG. 1) are aligned in rows. The m lines of data electrodes D1 to Dm (data electrode 32 in FIG. 1) are aligned in columns. A discharge cell is formed at a portion where a pair of scan electrode SCi and sustain electrode SUi (i=1 to n) cross one data electrode Dj (j=1 to m). In total, the m×n number of discharge cells are formed in a discharge space.

Next, a waveform of drive voltage for driving panel 10 is described. Here, an example of dividing one field into 10 subfields (first SF, second SF, . . . and tenth SF) is given. Subfield is weighed with luminance of 1, 2, 3, 6, 11, 18, 30, 44, 60, and 80, respectively.

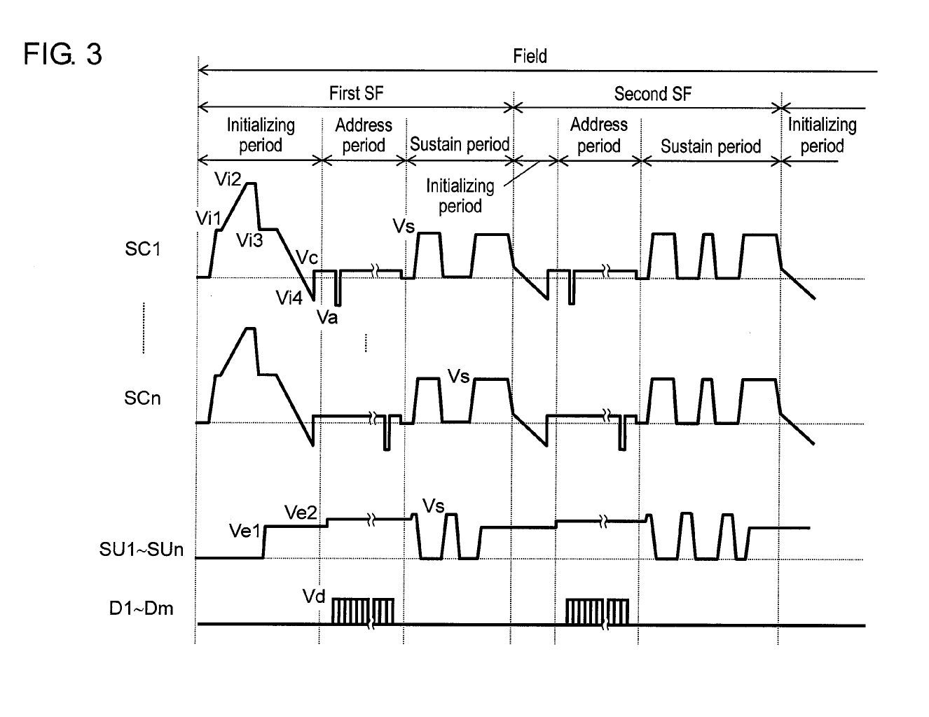

FIG. 3 is the drive voltage waveform applied to each electrode of panel 10 of the plasma display device in the exemplary embodiment of the present invention.

In the initializing period, data electrodes D1 to Dm and sustain electrodes SU1 to SUn are retained at 0V, and ramp voltage is applied to scan electrodes SC1 to SCn in a first half of the period. This ramp voltage gently rises from voltage Vi1, which is the same or lower than discharge start voltage, to voltage Vi2, which is higher than the discharge start voltage. Then, faint initializing discharge occurs in all discharge cells, and wall voltage is accumulated on scan electrodes SC1 to SCn, sustain electrodes SU1 to SUn, and data electrodes D1 to Dm. The wall voltage on electrodes refers to voltage generated by wall charge accumulated on the dielectric layer or phosphor layer covering the electrodes.

In a subsequent second half of the period, sustain electrodes SU1 to SUn are retained at voltage Ve1, and ramp voltage is applied to scan electrodes SC1 to SCn. This ramp voltage gently falls from voltage Vi3 to voltage Vi4. Then, faint initializing discharges occur in all discharge cells again, and wall voltage on scan electrodes SC1 to SCn, sustain electrodes SU1 to SUn, and data electrodes D1 to Dm is adjusted to an appropriate value for the address operation.

The first half of the initializing period may be omitted in several subfields in the subfields which compose one field. In this case, the initializing operation is applied selectively to a discharge cell where sustain discharge takes place in an immediately preceding subfield. FIG. 3 illustrates the drive voltage waveform for the initializing operation including the first half and the second half in the initializing period for first SF, and the initializing operation including only the second half of the initializing period for subfields on and after second SF.

In the address period, voltage Ve2 is applied to sustain electrodes SU1 to SUn. Address pulse voltage Vd is applied to data electrode Dk (k=1 to m) of discharge cells to emit light in the first line out of data electrodes D1 to Dm. At the same time, scan pulse voltage Va is applied to scan electrode SC1 in the first line. Then, address discharge occurs between data electrode Dk and scan electrode SC1, and between sustain electrode SU1 and scan electrode SC1, resulting in accumulating positive wall voltage on scan electrode SC1 and negative wall voltage on sustain electrode SU1 of this discharge cell. The address operation is executed in this way by generating address discharge at discharge cells to be lighted in the first line, and accumulating wall voltage on each electrode. On the other hand, no address discharge occurs at a crossing portion between scan electrode SC1 and data electrode Dh (h≠k) to which address pulse voltage Vd is not applied. This address operation is sequentially executed until discharge cells on the n line, and the address period completes.

In the subsequent sustain period, sustain electrodes SU1 to SUn return to 0V, and sustain pulse voltage Vs is applied to scan electrodes SC1 to SCn. Wall voltage on scan electrode SCi and sustain electrode SUi is added to sustain pulse voltage Vs in voltage applied between scan electrode SCi and sustain electrode SUi in the discharge cell that generated address discharge, exceeding discharge start voltage. This generates sustain discharge between scan electrode SCi and sustain electrode SUi, and emits light. At this point, negative wall voltage is accumulated on scan electrode SCi, and positive wall voltage accumulates on sustain voltage SUi. Next, scan electrodes SC1 to SCn return to 0V, and sustain pulse voltage Vs is applied to sustain electrodes SU1 to SUn. Then, voltage applied between sustain electrode SUi and scan electrode SCi in a discharge cell that generated sustain discharge exceeds discharge start voltage. Accordingly, sustain discharge is generated again between sustain electrode SUi and scan electrode SCi. Negative wall voltage thus accumulates on sustain electrode SUi and positive wall voltage accumulates on scan electrode SCi. In the same way, sustain discharge continues in a discharge cell that generated address discharge in the address period by applying sustain pulse voltage proportionate to the weight of luminance to scan electrodes SC1 to SCn and sustain electrodes SU1 to SUn. No sustain discharge is generated in a discharge cell in which address discharge is not generated in the address period. Wall voltage on completing the initializing period is retained in this discharge cell. Now, the sustain operation in the sustain period completes.

In subsequent second SF to tenth SF, the initializing period and address period are the same as that for the first SF. In the sustain period, the sustain operation same as that in the sustain period of first SF takes place except for the number of sustain pulses. Accordingly, each subfield of a discharge cell is controlled to emit light or not so as to display an image in multi-gradations by combining luminance weights of subfields.

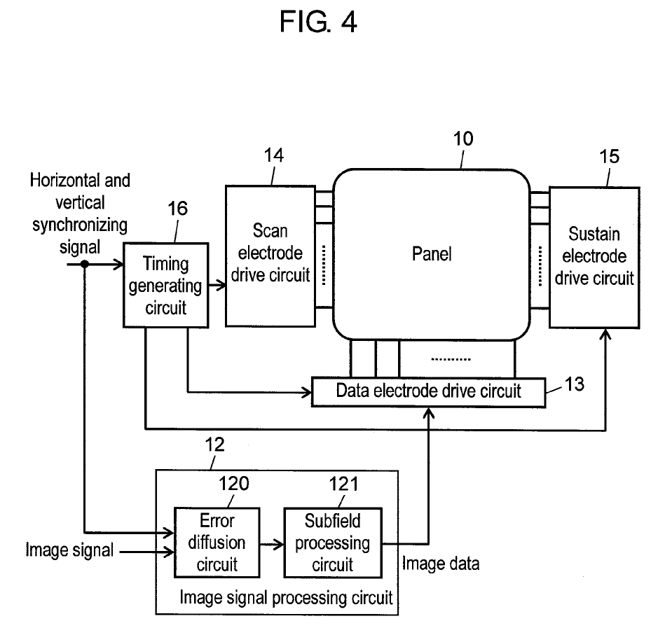

FIG. 4 is a circuit block diagram of the plasma display device in the exemplary embodiment of the present invention. This plasma display device includes panel 10, image signal processing circuit 12, data electrode drive circuit 13, scan electrode drive circuit 14, sustain electrode drive circuit 15, timing generating circuit 16, and power supply circuit (not illustrated). In this exemplary embodiment, the number of bits of input image data is 12 bits, and the number of bits of displayable image data is 8 bits. However, the present invention is not limited to these numbers of bits.

Image signal processing circuit 12 includes error diffusion circuit 120 and subfield processing circuit 121. An input image signal is converted to image data for each subfield. Error diffusion circuit 120 converts a 12-bit input image signal (hereafter referred to as “input image data”) to 8-bit output image data. Subfield processing circuit 121 converts output image data output from error diffusion circuit 120 to image data for each subfield.

Data electrode drive circuit 13 converts image data for each subfield to a signal corresponding to each of data electrodes D1 to Dm, and drives each of data electrodes D1 to Dm. Timing generating circuit 16 generates a range of timing signals using horizontal synchronizing signal and vertical synchronizing signal, and supplies these timing signals to data electrode drive circuit 13, scan electrode drive circuit 14, and sustain electrode drive circuit 15. Scan electrode drive circuit 14 supplies drive voltage waveform shown in FIG. 3 to scan electrodes SC1 to SCn based on a timing signal. Sustain electrode drive circuit 15 supplies drive voltage waveform shown in FIG. 3 to sustain electrodes SU1 to SUn based on a timing signal.

Next, a structure of error diffusion circuit 120 of the plasma display device in the exemplary embodiment of the present invention is described.

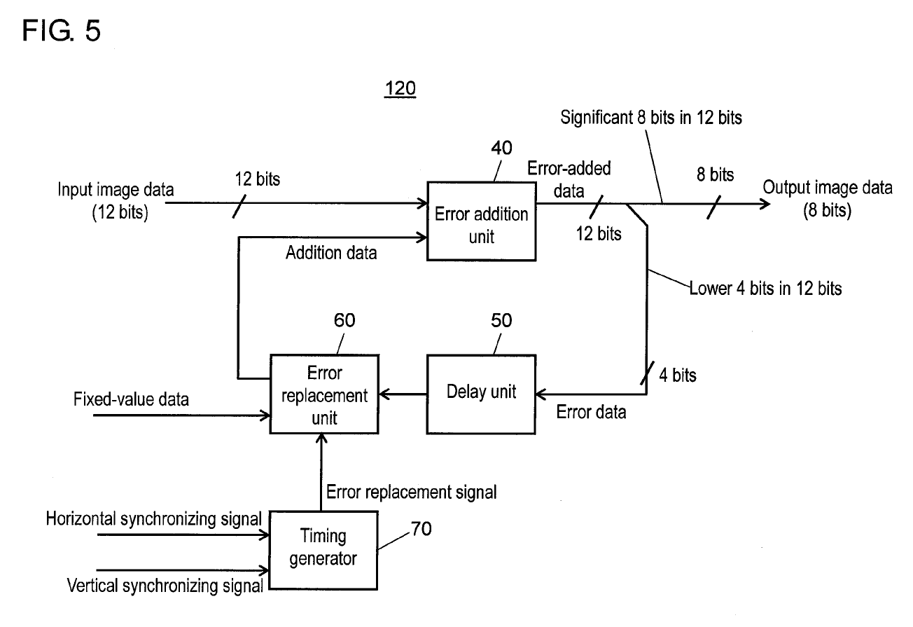

FIG. 5 is a circuit block diagram of error diffusion circuit 120 of the plasma display device in the exemplary embodiment of the present invention. Error diffusion circuit 120 includes error addition unit 40, delay unit 50, error replacement unit 60, and timing generator 70. Error diffusion circuit 120 limits the gradation level of input image signal to that displayable on the plasma display device, which is a display device. At the same time, error diffusion circuit 120 diffuses the error data produced by limiting the number of bits to neighboring pixels. In FIGS. 5, 7, 9, 10, and 11, the image signal is indicated as “input image data.”

Error addition unit 40 adds 12-bit input image data and addition data output from error replacement unit 60, and outputs 12-bit error added data. The significant 8 bits of the error-added data are then output to subfield processing circuit 121 as output image data, and the lower 4 bits are output to delay unit 50 as error data.

Delay unit 50 includes the number of delay devices equivalent to the number of pixels where error data is diffused. Delay unit 50 supplies the 4-bit error data supplied from error addition unit 40 to error replacement unit 60 after delaying a predetermined time corresponding to each pixel in the destination.

Error replacement unit 60 retains fixed-value data that is data containing a predetermined fixed value. Error replacement unit 60 switches and supplies error data from delay unit 50 or fixed-value data to error addition unit 40, corresponding to an error replacement signal from timing generator 70. Timing generator 70 generates the error replacement signal based on the horizontal synchronizing signal and vertical synchronizing signal, and supplies it to error replacement unit 60.

In this exemplary embodiment, the error replacement signal is at high level H for a predetermined period before the image signal to be displayed on a display screen of the image display device is input to error diffusion circuit 120. At all other periods, the error replacement signal is at low level L. This predetermined period is a period before the image signal to be displayed on the display screen is input to error addition unit 40 in one vertical scan period of the image signal and a predetermined period before the image signal to be displayed on the display screen is input to error addition unit 40 in one horizontal scan period of the image signal. While the error replacement signal is at high level H (hereafter referred to as the “error replacement period”), error replacement unit 60 outputs the fixed-value data. In other periods, a value related to error data is output.

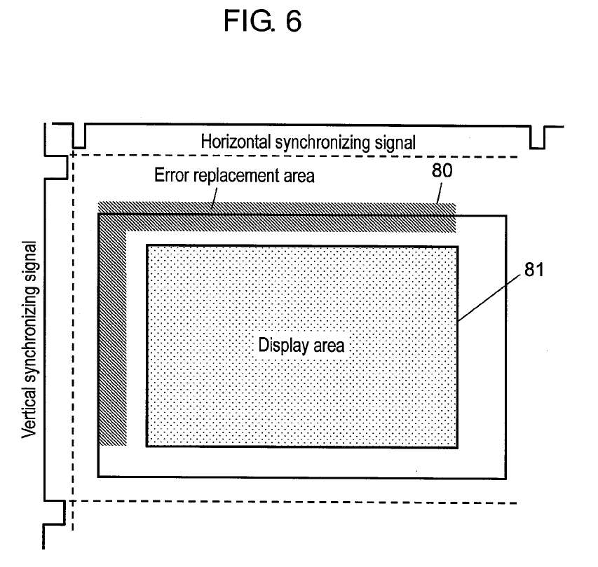

FIG. 6 illustrates the error replacement period in the exemplary embodiment of the present invention. In FIG. 6, the area where image signals are displayed in the image display device is display area 81, and an area corresponding to a predetermined period before displaying image signals in display area 81 is imaginary area 80. Hereafter, imaginary area 80 is referred to as the “error replacement area.” As described above, error replacement area 80 is an area corresponding to the predetermined period before the image signal to be displayed on the display screen is input to error addition unit 40 in one vertical scan period of the image signal, and the predetermined period before the image signal to be displayed on the display screen is input to error addition unit 40 in one horizontal scan period of the image signal. FIG. 6 illustrates the horizontal synchronizing signal, vertical synchronizing signal, and positions of display area 81 and error replacement area 80.

In this exemplary embodiment, error replacement area 80 is a period of four lines before the image signal to be displayed in display area 81 is input to error addition unit 40 in one vertical scan period and a period of 10 pixels before the image signal to be displayed in display area 81 is input to error addition unit 40 in one horizontal scan period. However, the present invention is not limited to this period. The period can be set as required in accordance with specifications of the display device.

In general, image information is superimposed for a longer period than a period corresponding to the display area of the image display device. The area where image information is superimposed is thus larger than display area 81 shown in FIG. 6. Accordingly, error replacement area 80 may overlap the area where image information is superimposed.

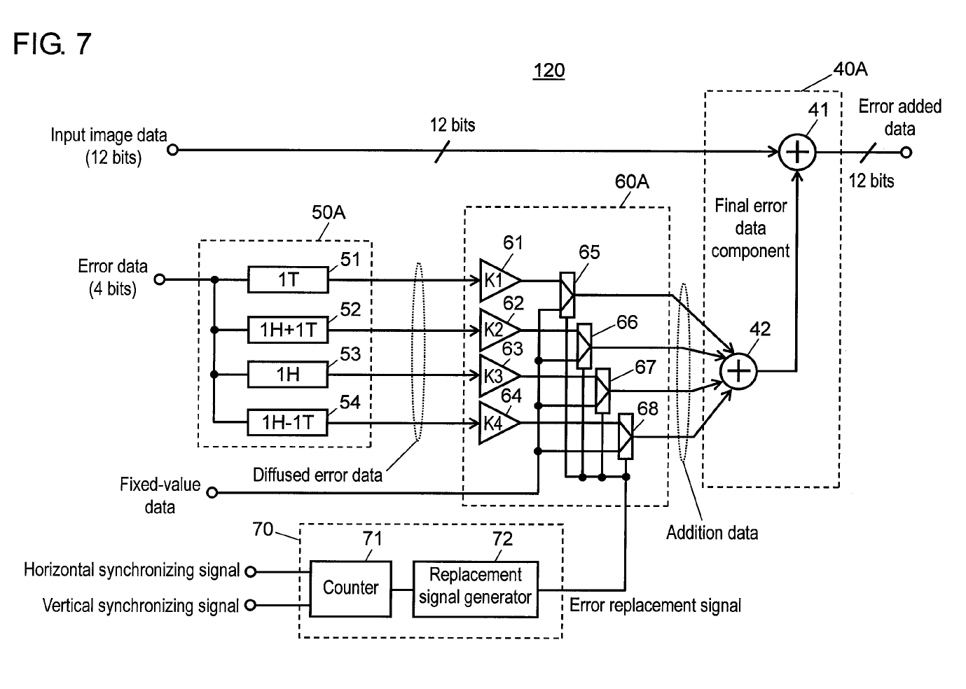

Next, the detailed structure of error diffusion circuit 120 in the exemplary embodiment is described. FIG. 7 is a block diagram illustrating details of a key part of error diffusion circuit 120 in this exemplary embodiment of the present invention.

Delay unit 50A is an example of a specific structure of delay unit 50 in FIG. 5. Delay unit 50A includes delay device 51, delay device 52, delay device 53, and delay device 54. Delay device 51 delays error data for one pixel (1 T). Delay device 52 delays error data for one line and one pixel (1 H+1 T). Delay device 53 delays error data for one line (1 H). Delay device 54 delays error data for one line minus one pixel (1 H−1 T). Delay device 51 thus diffuses error data to the right pixel of a target pixel, delay device 54 diffuses error data to the lower left pixel of the target pixel, delay device 53 diffuses error data to the pixel below the target pixel, and delay device 52 diffuses error data to the lower right pixel to the target pixel. On the other hand, seen from the target pixel, output of delay unit 50A is error diffused from neighboring pixels of the target pixel. Delay device 51 outputs error from the left pixel, delay device 52 outputs error from the upper left pixel, delay device 53 outputs the error from the upper pixel, and delay device 54 outputs the error from the upper right pixel. The output data from each delay device of delay unit 50A is supplied to error replacement unit 60A as diffusion error data.

Error replacement unit 60A is an example of a specific structure of error replacement unit 60 in FIG. 5. Error replacement unit 60A includes multiplier 61, multiplier 62, multiplier 63, multiplier 64, selector 65, selector 66, selector 67, and selector 68. Multiplier 61 multiplies diffusion error data from delay device 51 by K1, and multiplier 62 multiples diffusion error data from delay device 52 by K2. Multiplier 63 multiplies diffusion error data from delay device 53 by K3, and multiplier 64 multiplies diffusion error data from delay device 54 by K4. Selector 65 switches between output data of multiplier 61 and fixed-value data. Selector 66 switches between output data of multiplier 62 and fixed-value data. Selector 67 switches between output data of multiplier 63 and fixed-value data. Selector 68 switches between output data of multiplier 64 and fixed-value data. Multiplier 61 multiplies error data diffused from the left pixel by K1, and multiplier 62 multiplies error data diffused from the upper left pixel by K2. Multiplier 63 multiplies error data diffused from the upper pixel by K3, and multiplier 64 multiplies error data diffused from the upper right pixel by K4. Coefficients are preferably set to satisfy the relationship of K1+K2+K3+K4=1. In this exemplary embodiment, K1 is 7/16, K2 is 1/16, K3 is 5/16, and K4 is 3/16. However, the present invention is not limited to these values. As long as the relationship of K1+K2+K3+K4=1 is satisfied, any values may be set. Alternatively, each coefficient may be switched in units of pixels or frames for error diffusion.

Also in this exemplary embodiment, error data of the target pixel is diffused to four neighboring pixels after multiplying the error data by the respective coefficients. However, the present invention is not limited to this operation. Error data of the target pixel may be diffused to four or more neighboring pixels after multiplying the error data by the respective coefficients.

Each of selectors 65 to 68 switches between outputs of corresponding multipliers 61 to 64 and fixed-value data in accordance with the error replacement signal.

Timing generator 70 includes counter 71 that generates a range of timing pulses based on horizontal synchronizing signal or vertical synchronizing signal, and replacement signal generator 72 for generating the error replacement signal in accordance with the timing pulse output from counter 71.

Error addition unit 40A is an example of a specific structure of error addition unit 40 in FIG. 5. Error addition unit 40A includes adder 42 for adding outputs from selectors 65 to 68, and adder 41 for adding the input image data and output of adder 42. Adder 42 adds an error component diffused from a pixel before the present target pixel, and supplies it to adder 41 as the final error data component corresponding to the present target pixel. Adder 41 adds the 12-bit input image data and 4-bit final error data component from adder 42, and outputs 12-bit error-added data.

Next, the operation of error diffusion circuit 120 in the exemplary embodiment of the present invention is further described.

First, the operation in a period when the error replacement signal is at low level L, i.e., a period other than the error replacement period, is described.

In this period, the input image data, to which image information to be displayed in the display area is superimposed, is input to error addition unit 40A. Error addition unit 40A outputs 12-bit error-added data of a pixel corresponding to the image data under error diffusion processing (hereafter referred to as a “target pixel”). Out of this error-added data, lower 4 bits are input to delay unit 50A as error data of the target pixel. Delay devices 51 to 54 of delay unit 50A delays the error data of the target pixel until the time of error diffusion of each signal corresponding to the right pixel, lower right pixel, bottom pixel, and lower left pixel of the target pixel. The diffusion error data delayed by delay devices 51 to 54, respectively, is multiplied by predetermined coefficients, respectively, in corresponding multipliers 61 to 64 of error replacement unit 60A. Coefficient K1 is 7/16, coefficient K2 is 1/16, coefficient K3 is 5/16, and coefficient K4 is 3/16. Outputs of multipliers 61 to 64 are added in adder 42 via corresponding selectors 65 to 68, and they are then added to input image data in adder 41.

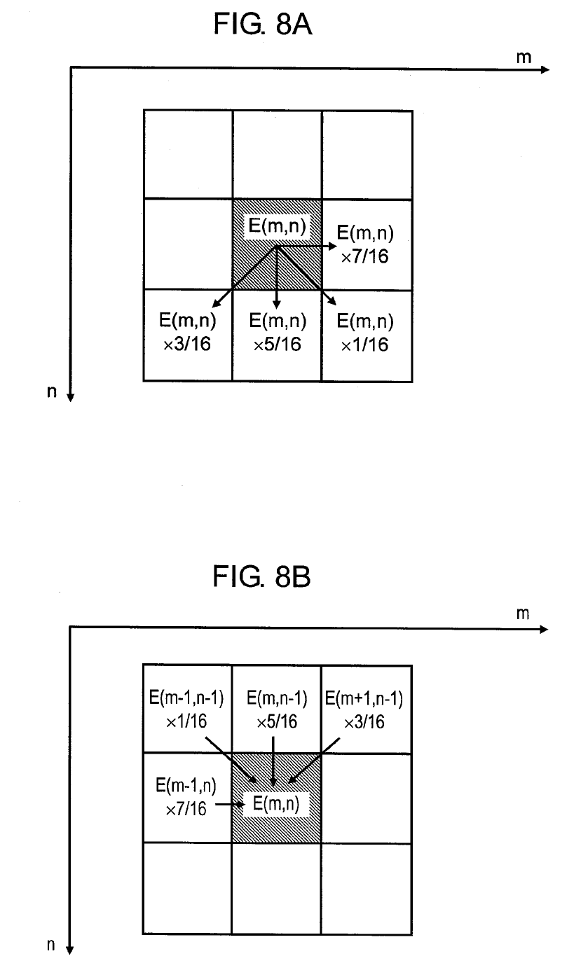

FIGS. 8A and 8B illustrate how error data is diffused in the exemplary embodiment of the present invention, and shows 3×3 pixels centering on the target pixel. As shown in FIG. 8A, error data E (m, n) of the target pixel (m and n are coordinates in the display screen) is multiplied by coefficients K1 to K4, respectively, and added to the input image data corresponding to four adjacent neighboring pixels. In addition, error from four adjacent neighboring pixels are diffused to the target pixel, as shown in FIG. 8B. Diffusion error data diffused from the surrounding is multiplied by coefficients K1 to K4, and then added to the input image data. The lower 4 bits of this error-added data is error data E (m, n) in the target pixel, and delay unit 50A diffuses this error data to neighboring pixels of the target pixel, as shown in FIG. 8A. This error diffusion processing is applied to all pixels to output 8-bit output image data from the 12-bit input image data.

Next, the operation in a period when the error replacement signal is at high level H, i.e., the error replacement period, is described.

Timing generator 70 switches the error replacement signal to high level H at the error replacement timing corresponding to error replacement area 80 shown in FIG. 6, based on the horizontal synchronizing signal and vertical synchronizing signal. Selectors 65 to 68 of error replacement unit 60A then select the fixed-value data. The fixed-value data is preferably data whose sum of errors diffused from neighboring pixels is smaller than the maximum value of the error data, and the same or larger than half the maximum value. Further, this sum in the data is preferably around ¾ of the maximum value. In this exemplary embodiment, the maximum value of error data is 15, since the error data consists of 4 bits. Accordingly, for example, fixed-value data in FIG. 7 may be set to 3. In other words, in this case, error diffused to the right pixel (error diffused from the left pixel when seen from the target pixel) is set to “3” in selector 65, and the error diffused to the lower right pixel (error diffused from the upper left pixel when seen from the target pixel) is set to “3” in selector 66. The error diffused to the bottom pixel (error diffused from the upper pixel when seen from the target pixel) is set to “3” in selector 67, and error diffused to the lower left pixel (error diffused from the upper right pixel when seen from the target pixel) is set to “3” in selector 68. In this way, the sum of replacement error data of diffused error is added to the input image data. The sum of errors diffused from neighboring pixels is thus “12,” which is close to ¾ of the maximum value “15” in the error data. Thus, this is the value preferable as a value of fixed-value data. The result of replacing diffused errors with fixed values during the error replacement period is added to the input image data in error addition unit 40A as the “final error data component.”

In the error replacement period, the fixed-value data is supplied from error replacement unit 60A to error addition unit 40A as addition data. If the input image data is “0,” the error-added data output from error addition unit 40A is equivalent to four times the fixed-value data. Delay unit 50A delays error data output from error addition unit 40A. The fixed-value data diffuses and spreads by repeating this operation during the error replacement period.

Error diffusion circuit 120 in this exemplary embodiment executes error diffusion for diffusing the fixed-value data in the error replacement area 80 so as to forcibly produce error data. Accordingly, sufficient error data can be accumulated before the timing to display an image.

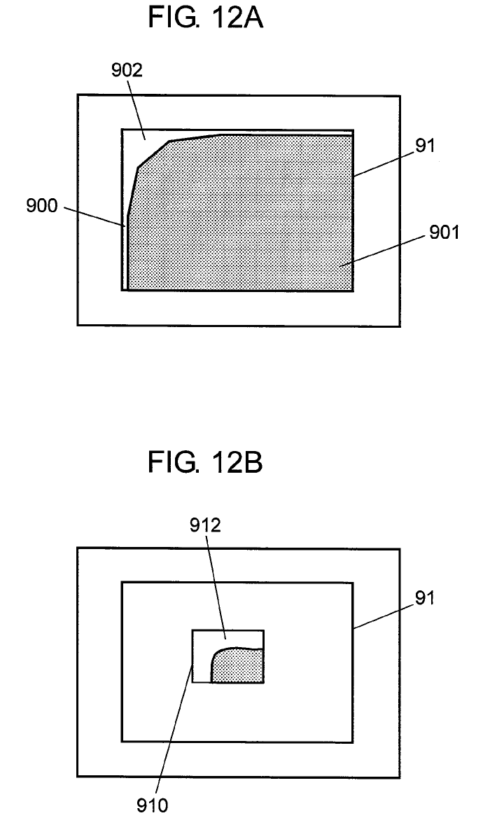

Supposing that the image display device in this exemplary embodiment receives input image data whose gradation in the entire area of display area 81 is “1” and the image is displayed after error diffusion. In this case, error data is replaced with the fixed-value data in error replacement area 80. This replaced fixed-value data spreads as the error data also in display area 81. The error data can thus be sufficiently accumulated. Accordingly, chipping of the image at the left or top, as shown in FIG. 12A, is prevented, and a rectangular image corresponding to the input image data can be accurately displayed.

Next, supposing that the image display device in this exemplary embodiment receives input image data whose gradation in its small area inside the display area is “1” and gradation of other area is “0,” and the image is displayed after error diffusion. Also in this case, error data is replaced with four-fold fixed-value data in error replacement area 80. The error data of the fixed-value data in error replacement area 80 spreads in a background area whose gradation is “0,” and thus error data is sufficiently accumulated in the small area inside the display area. Accordingly, uneven brightness, chipping, or positional deviation at the top, left, and upper left parts, as shown in FIG. 12B, is prevented, Accordingly, a rectangular image corresponding to the input image data can be accurately displayed.

In the above description, the structure of error diffusion circuit 120 is described with reference to FIG. 7. Error diffusion circuit 120 shown in FIG. 7 delays error data output from error addition unit 40A by delay unit 50A, multiplies the error data by respective coefficient in multipliers 61 to 64, and then adds data by adder 42 via selectors 65 to 68 for replacing the error data. However, the present invention is not limited to this structure. The order of multipliers 61 to 64, selectors 65 to 68, and adder 42 may be switched.

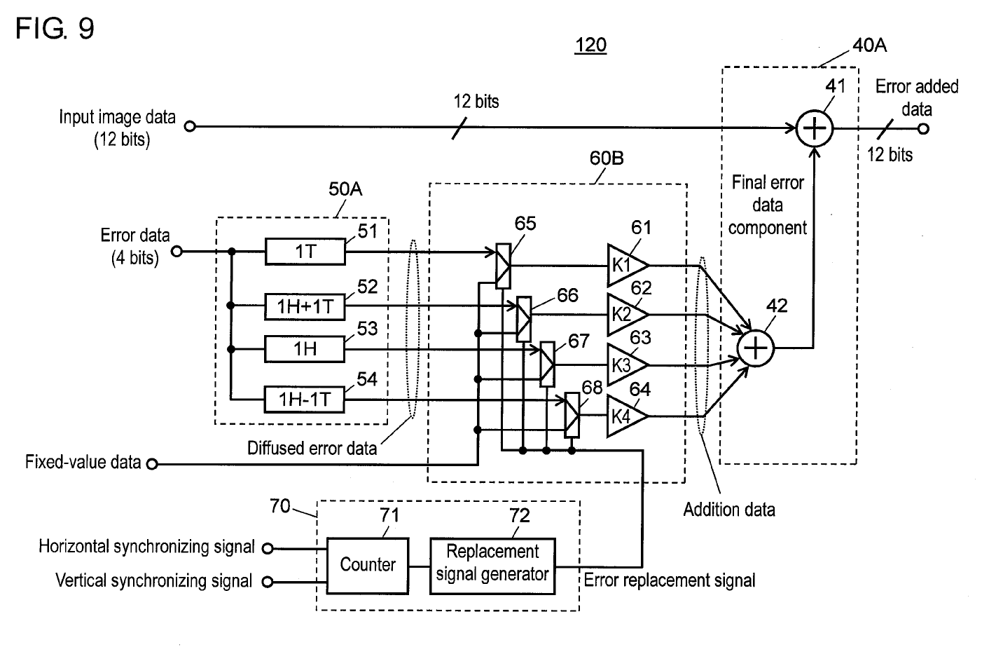

FIG. 9 is a block diagram illustrating details of a key part of another error diffusion circuit 120 in the exemplary embodiment of the present invention. Error diffusion circuit 120 shown in FIG. 9 delays error data output from error addition unit 40A by delay devices 51 to 54, and inputs this data to selectors 65 to 68. Then, error diffusion circuit 120 replaces the error data if required, as described above, by selectors 65 to 68, and multiplies the data by coefficient in multipliers 61 to 64. Then, the data is added in adder 42.

Same reference marks are given to the same components in FIGS. 7 and 9. Accordingly, details of the structure and operation given the same reference marks in FIG. 9 as those in FIGS. 7 are omitted.

Error replacement unit 60B is another example of a specific structure of error diffusion unit 60 shown in FIG. 7. Error replacement unit 60B includes selectors 65 to 68 and multipliers 61 to 64.

In error diffusion circuit 120 in FIG. 7, the fixed-value data do not pass through multipliers 61 to 64. However, in error diffusion circuit 120 in FIG. 9, the fixed-value data passes through multipliers 61 to 64. Accordingly, if selectors 65 to 68 select the fixed-value data, the fixed-value data is multiplied by respective coefficients in multipliers 61 to 64. As a result, the fixed-value data output from adder 42 becomes ¼ of that in FIG. 7. The fixed-value data is thus preferably set to four times of that in FIG. 7.

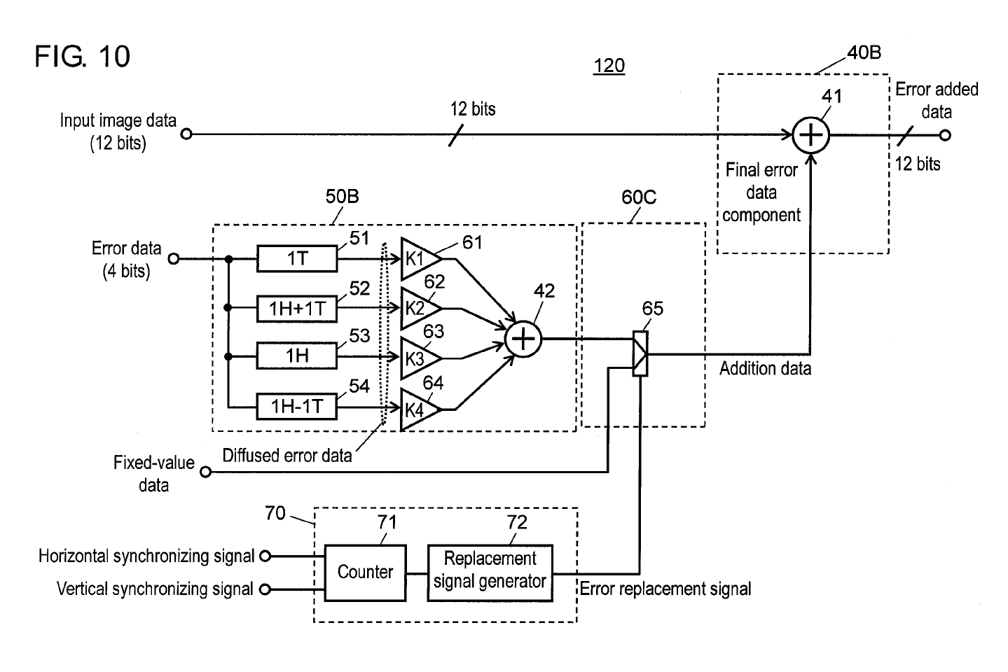

FIG. 10 is a block diagram illustrating a detailed structure of a key part of still another error diffusion circuit 120 in the exemplary embodiment of the present invention. Positions of the selectors and the adders are switched in error diffusion circuit 120 shown in FIG. 10. In the error replacement period, the error data diffused from four neighboring pixels is added in adder 42, and then replaced with the fixed-value data.

Same reference marks are given to the same components in FIGS. 7, 9 and 10. Accordingly, details of the structure and operation given the same reference marks in FIG. 10 as those in FIGS. 7 and 9 are omitted.

In FIG. 10, error addition unit 40B is an example of another specific structure of error addition unit 40 in FIG. 5. Error addition unit 40B includes adder 41. Delay unit 50B is an example of another specific structure of delay unit 50 in FIG. 5. Delay unit 50B includes delay devices 51 to 54, multipliers 61 to 64, and adder 42. Error replacement unit 60C is an example of another specific structure of error replacement unit 60 in FIG. 5. Error replacement unit 60C includes selector 65.

Error diffusion circuit 120 shown in FIG. 10 delays error data output from error addition unit 40B by delay devices 51 to 54, and multiplies the error data by respective coefficients in multipliers 61 to 64. After addition in adder 42, selector 65 replaces with the error data.

In error diffusion circuit 120 shown in FIG. 7, the fixed-value data do not pass through multipliers 61 to 64. In error diffusion circuit 120 in FIG. 10, the fixed-value data also do not pass through multipliers 61 to 64. Therefore, even if selector 65 selects the fixed-value data, the fixed-value-data output from selector 65 is the same as that in FIG. 7 since the fixed-value data is not multiplied in multipliers 61 to 64. The fixed-value data is thus preferably set to four times of that in FIG. 7.

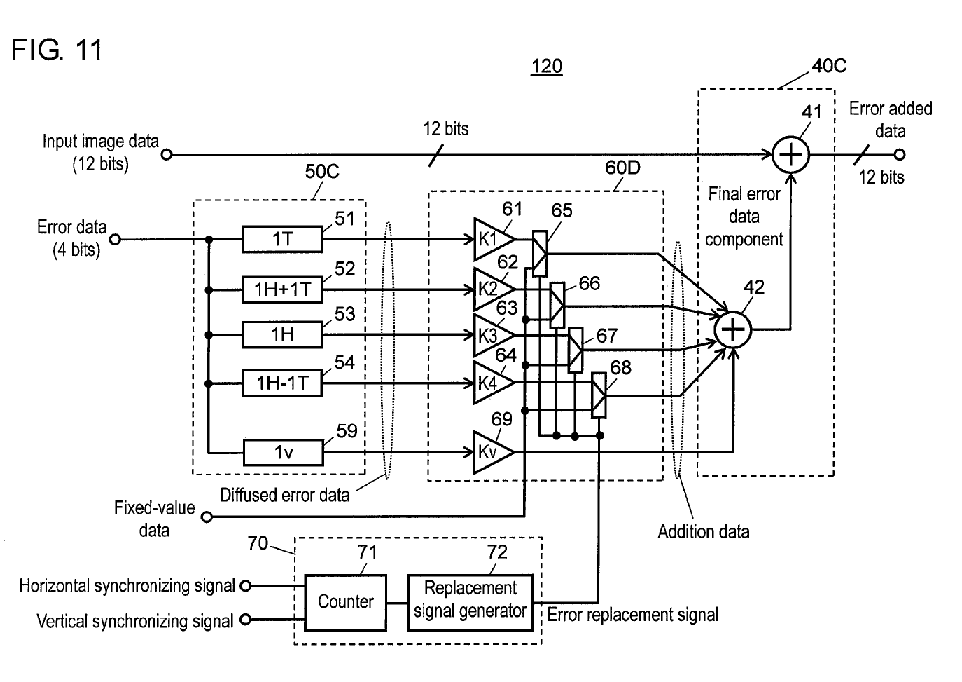

FIG. 11 is a block diagram illustrating details of a key part in still another error diffusion circuit 120 in this exemplary embodiment. Error diffusion circuit 120 in FIG. 11 diffuses error data to neighboring pixels of the target pixel, and also diffuses to a pixel in a next field.

Same reference marks are given to the same components in FIGS. 7, 9, 10, and 11. Accordingly, details of the structure and operation given the same reference marks in FIG. 11 as those in FIGS. 7, 9, and 10 are omitted.

In FIG. 11, error addition unit 40C is an example of still another structure of error addition unit 40 in FIG. 5. Error addition unit 40C includes adder 41 and adder 42. Adder 42 adds outputs from selectors 65 to 68 and an output from multiplier 69. Delay unit 50C is an example of still another structure of delay unit 50 in FIG. 5. Delay unit 50C includes delay devices 51 to 54 and 59. Error replacement unit 60D is an example of still another structure of error replacement unit 60 in FIG. 5. Error replacement unit 60D includes multipliers 61 to 64 and 69 and selectors 65 to 68.

More specifically, delay unit 50C in FIG. 11 includes delay device 59 for delaying error data for one field, in addition to the structure of delay unit 50A shown in FIG. 7. This delay device 59 delays error data of the target pixel for one field. Error replacement unit 60D includes multiplier 69 for multiplying output of delay device 59 by coefficient Kv, in addition to error replacement unit 60A shown in FIG. 7. Error diffusion circuit 120 in FIG. 11 thus includes an additional function to add the error data to image data of a target pixel in the next field by adder 42 after delaying the error data for one field by delay device 59, and multiplying the error data by a coefficient in multiplier 69.

Accordingly, how the error data is diffused by error diffusion circuit 120 in FIG. 11 is the same as that shown in FIGS. 8A and 8B within the field. However, error diffusion circuit 120 in FIG. 11 differs with error diffusion circuit 120 shown in FIGS. 7, 9, and 10 in a point that the error data is also diffused across the fields.

Error diffusion circuit 120 in FIG. 11 supplies the error data to five multipliers 61 to 64 and 69, while error diffusion circuit 120 in FIGS. 7, 9, and 10 supply the error data to four multipliers 61 to 64. Accordingly, values in coefficients K1 to K4 may be different from values in coefficients K1 to K4 in FIGS. 7, 9, and 10. Coefficients K1 to K4 and Kv are preferably set such that their sum is 1.

The structure of the error diffusion circuit diffusing the error data to a pixel in the next field is not limited to that shown in FIG. 11. Delay device 59 may be added to the structure shown in FIGS. 9 and 10.

In this exemplary embodiment, the error data of the target pixel is diffused to all neighboring pixels in the right, lower left, bottom, and lower right of the target pixel. However, the present invention is not limited to this structure. The error data may be diffused to one neighboring pixel to the right, lower left, bottom, or lower right of the target pixel.

Further, in the exemplary embodiment, the error data from all neighboring pixels to the left, upper left, top, and upper right of the target pixel is replaced in the error replacement period. However, the present invention is not limited to this structure. The error data from at least one of the neighboring pixels to the left, upper left, top, and upper right of the target pixel may be replaced.

Specific numeric values given in the exemplary embodiment are given only as examples. An appropriate value is preferably set as required based on the panel characteristics and the specifications of the image display device. The exemplary embodiment also refers to the structure of replacing errors diffused to the target pixel in the error replacement period after being delayed by the delay device. However, the present invention is not limited to this structure. An error may be replaced in the error replacement period before the delay device delays the error.

### INDUSTRIAL APPLICABILITY

The image display device of the present invention suppresses the occurrence of uneven brightness and positional deviation of an image without loss of picture quality of the displayed image, regardless of the image display position or the size of the input signal. Accordingly, the present invention is efficiently applicable to image display devices employing a plasma display panel.

1. An image display device in which one field comprises a plurality of subfields, the image display device displaying an image in multi-gradations by controlling on and off of light emission from each pixel of the display device in each of the subfields, the image display device comprising:
an error diffusion circuit for limiting an image signal to a grayscale level displayable on the display device, and diffusing error data produced by the limitation to neighboring pixels, the error diffusion circuit comprising:
an error replacement unit for replacing the error data with predetermined fixed-value data during:
a predetermined period before an image signal to be displayed on a display screen is input to the error diffusion circuit in one vertical scan period of the image signal; and
a predetermined period before an image signal to be displayed on a display screen is input to the error diffusion circuit in one horizontal scan period of the image signal.

2. The image display device of claim 1, wherein a sum of the fixed-value data diffused from the neighboring pixels is less than a maximum value of the error data and not less than half the maximum value.

3. The image display device of claim 1, wherein the error diffusion circuit replaces the error data diffused from at least one pixel in the neighboring pixels with the fixed-value data in the predetermined period.
